(19) United States
(12) Patent Application Publication
(10) Pub. No.: US 2010/0164755 A1
(43) Pub. Date: Jul. 1, 2010

(54) ELECTRONIC APPARATUS AND ELECTRONIC SYSTEM

(75) Inventors: Yukisuke Ozaki, Kobe (JP); Daisuke Baba, Kobe (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/451,768

(22) PCT Filed: Apr. 30, 2008
(86) PCT No.: PCT/JP2008/058285

§ 371 Date: Nov. 30, 2009

(30) Foreign Application Priority Data
May 31, 2007 (JP) 2007-146297

(51) Int. Cl. G08G 1/123; G06F 3/041

(52) U.S. Cl. 340/995.26; 345/173

(57) ABSTRACT

The present invention is an electronic system and an electronic apparatus 100 from which a portable apparatus 10 is detachable, and which includes a controller 140 being capable of controlling controlled portions 134 and 135. The controller 140 recognizes a current mode of the controlled portions 134 and 135 when an operation signal is input to the controller from the portable apparatus 10, selects a control content on the basis of the current mode and the operation signal, and controls the controlled portion currently being controlled on the basis of the selected control content.

### TECHNICAL FIELD

This invention relates to electronic apparatuses and electronic systems, more particular, to an electronic apparatus to which a portable apparatus is attached and an electronic system.

### BACKGROUND ART

As conventional navigation apparatuses, there are widely known small-sized portable navigation apparatuses with a simplified structure and its portability (hereinafter, referred to as Portable Navi), also known as Personal Navigation Device; and in-vehicle navigation apparatuses accommodated and secured to a recess portion (DIN opening) formed in a dashboard of a vehicle. The in-vehicle navigation apparatuses are capable of guiding with high accuracy by use of the information supplied from vehicles such as vehicle speed, and some of the in-vehicle navigation apparatuses are equipped with audio devices.

In recent years, the navigation apparatuses with portability of the Portable Navi and high-accuracy guide function of the in-vehicle navigation apparatus have been studied.

Patent Documents 1 and 2 disclose a configuration where a CD unit is detachable from an in-vehicle apparatus. Patent Documents 3 and 4 disclose a configuration where a navigation portion is detachable from an in-vehicle apparatus mounted in a vehicle. By removing the navigation portion from the in-vehicle apparatus, the navigation portion can be used as a Portable Navi of a single unit. Also, as disclosed in Patent Document 5, the navigation apparatus is taken out of the vehicle and can be used while walking. In addition, when mounted in a vehicle, the navigation apparatus is in a car-navigation mode, and when taken out of the vehicle, the navigation apparatus is in a person-navigation mode.

### Patent Document 1: Japanese Patent Application Publication No. 8-318792

### Patent Document 2: Japanese Patent Application Publication No. 2002-328026

### Patent Document 3: Japanese Patent Application Publication No. 2005-524570

### Patent Document 4: Japanese Patent Application Publication No. 2001-239895

### Patent Document 5: Japanese Patent Application Publication No. 2003-166848

### DISCLOSURE OF THE INVENTION

### Problems to be Solved by the Invention

When a portable apparatus (for example, a portable navigation) is attached in the in-vehicle apparatus mounted in a vehicle, a controlled portion such as a radio receiver provided in the in-vehicle apparatus can be controlled by operating a touch panel. In this case, the portable apparatus transmits operation signals associated with the operation of the touch panel.

For example, when a radio operation screen is displayed on a display screen of the portable apparatus and a frequency of radio is displayed on the radio operation screen, in order to set (preset) the frequency of the radio displayed on the display screen of the portable apparatus associated with a button 1 displayed on the touch panel, a user long presses the button 1 to set the frequency of the radio associated with the button 1. In this case, the portable apparatus transmits to a controller of the in-vehicle apparatus an operation signal, the operation signals being information that a communication command indicating that the button 1 displayed on the operation screen of the radio is long pressed.

Further, for example, in order to read a frequency registered to a button 3 displayed on the touch panel, a user short presses the button 3. In this case, the portable apparatus transmits to a controller of the in-vehicle apparatus operation signals indicating that a communication command indicating the button 3 displayed on the operation screen of the radio is short pressed.

Further, in a case where the portable apparatus is configured to control the plural controlled portion such as a CD operating portion, a DVD operating portion, in addition to the radio receiver, the number of operation signals has to be increased as according to operation buttons which are displayed as being associated with the number of the controlled portions.

In the above case where the portable apparatus controls the controlled portion provided in the in-vehicle apparatus, the portable apparatus is configured to have plural communication commands according to, for example, preset of radio operation, selection of a frequency and the like. Thus, when the controlled portions are increased and modes are varied, there is a problem that the number of the operation signals to be transmitted from the portable apparatus to the in-vehicle apparatus is increased.

The present invention has been made in view of the above circumstances and has an object to suppress the number of operation signals transmitted from a portable apparatus to an in-vehicle apparatus from being increased.

### Means for Solving the Problems

According to an aspect of the present invention, there is provided an electronic apparatus from which a portable apparatus is detachable, and which includes a controller being capable of controlling a controlled portion, the electronic apparatus characterized in that the controller recognizes a current mode of the controlled portion when an operation signal is input to the controller from the portable apparatus, selects a control content on the basis of the current mode and the operation signal, and controls the controlled portion currently being controlled on the basis of the selected control content. According to the present invention, even when the modes of the controlled portion increase, the number of the operation signals transmitted by the portable apparatus is not increased. This provides a simple configuration of the portable apparatus.

In the above configuration, the controller may detect a period while the operation signal is being input, and may select the control content of the controlled portion on the basis of the detected period. With this configuration, the number of the commands of the operation signals transmitted by the portable apparatus can be reduced.

In the above configuration, the portable apparatus may be a navigation apparatus displaying map information.

In the above configuration, the controlled portion may be a radio receiver for receiving radio broadcasting, and the controller may store or select radio information for controlling the radio receiver, on the basis of the selected control content.

In the above configuration, the controller may detect the period while the operation signal is being input, and may store the radio information when the detected period is more than or equal to a given period or may select the radio information when the detected period is less than or equal to the given period.

According to another aspect of the present invention, there is provided an electronic system including a portable apparatus having an operating portion and an electronic apparatus having a controller being capable of controlling a plurality of controlled portions, the electronic system characterized in that the controller recognizes a current mode of the controlled portion when an operation signal is input to the controller from the portable apparatus, selects a control content on the basis of the current mode and the operation signal, and controls the controlled portion currently being controlled on the basis of the selected control content. According to the present invention, even when the modes of the controlled portion increase, the number of the operation signals transmitted by the portable apparatus is not increased. This provides a simple configuration of the portable apparatus.

In the above configuration, the operating portion may include a touch panel.

In the above configuration, the portable apparatus may be a navigation apparatus displaying map information.

In the above configuration, the controlled portion may be a radio receiver for receiving radio broadcasting, and the controller may store or select radio information for controlling the radio receiver, on the basis of the selected control content.

In the above configuration, the controller may detect the period while the operation signal is being input, and may store the radio information when the detected period is more than or equal to a given period or may select the radio information when the detected period is less than or equal to the given period.

### EFFECTS OF THE INVENTION

According to the present invention, even when the modes of the controlled portion increase, the number of the commands of the operation signals transmitted by the portable apparatus is not increased. This provides a simple configuration of the portable apparatus.

### BRIEF DESCRIPTION OF THE DRAWINGS

FIG. 1A and FIG. 1B are schematic views of exterior views of an in-vehicle system employed in a first embodiment;

FIG. 2 is a schematic view of an in-vehicle apparatus, from which the portable apparatus is removed;

FIG. 3 is a schematic view of a state of tilting the front face portion against the main body of the in-vehicle apparatus to expose a CD insertion/ejection slot;

FIG. 4 is a schematic view of an example of mounting the in-vehicle system in a vehicle;

FIG. 5 is a block diagram of a schematic configuration of the in-vehicle system;

FIG. 6 is a front view of a main body;

FIGS. 7A to 7D are schematic views of a display of the portable apparatus attached to the main body;

FIG. 8A is a schematic view of a front view, top view, bottom view, left-side view, and right-side view of the portable apparatus, and FIG. 8B is a back view of the portable apparatus;

FIG. 9 is a schematic view for describing a configuration where a radio receiver 134 and a CD player 135 serving as controlled portions are controlled, and is a block view where main blocks are taken from the blocks illustrated in FIG. 5;

FIG. 10 is a flowchart (first) of operations of a controller;

FIGS. 11A to 11C are views of an example of a radio operation screen;

FIG. 12 is a view of an example of operation signals;

FIGS. 13A and 13B are views of an example of data stored in a memory;

FIG. 14 is a flowchart (second) of the operation of a controller of the in-vehicle apparatus;

FIG. 15 is view of an example of a CD operation; and

FIG. 16 is a flowchart (third) of the operation of the controller of the in-vehicle apparatus.

### BEST MODE FOR CARRYING OUT THE INVENTION

In the following, a description will be given of an embodiment with reference to the drawings.

### First Embodiment

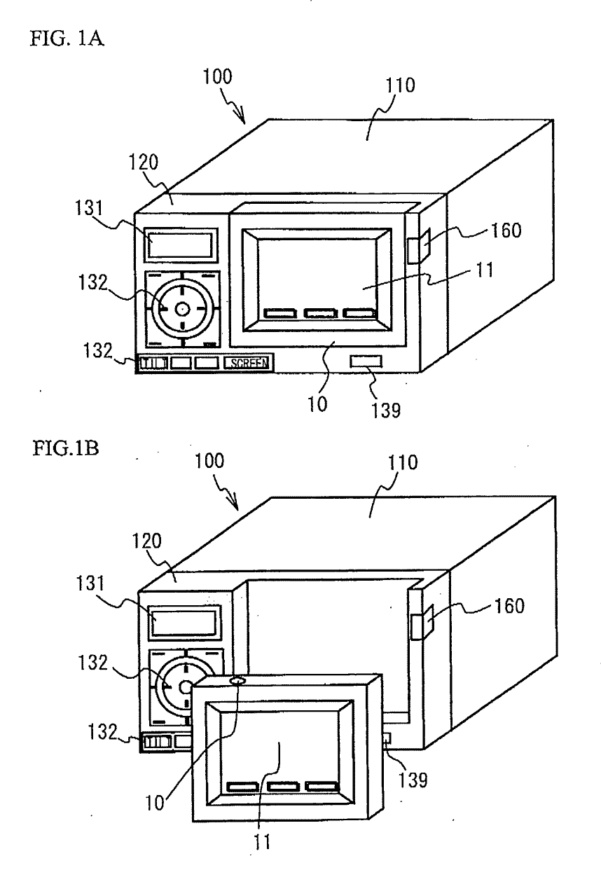

FIG. 1A and FIG. 1B show exterior views of an in-vehicle system 1 (an electronic system including a portable apparatus 10 and an in-vehicle apparatus 100), as an example of an electronic system. As shown in FIG. 1A and FIG. 1B, the in-vehicle system 1 is composed of: the in-vehicle apparatus 100 (in-vehicle electronic apparatus); and the portable apparatus 10 (portable display apparatus) with navigation capabilities. The portable apparatus 10 can be used after being attached at a front face portion 120 of the in-vehicle apparatus 100, as shown in FIG. 1A, and can be also used after being detached from the in-vehicle apparatus 100, as shown in FIG. 1B. In this manner, the portable apparatus 10 is detachable from the in-vehicle apparatus 100, and the portable apparatus 10 is attachable to the in-vehicle apparatus 100.

The in-vehicle apparatus 100 is capable of playing radio broadcasting or playing music data recorded on a memory medium such as a CD (Compact Disc) or the like, and the in-vehicle apparatus 100 includes: an in-vehicle apparatus main body 110 (main portion) having a CD player and a CD insertion/ejection slot; and the front face portion 120 having a display portion 131 and an operating portion 132. The portable apparatus 10 has navigation capabilities of searching for a guiding path to a destination and displaying the searched guiding path over a map.

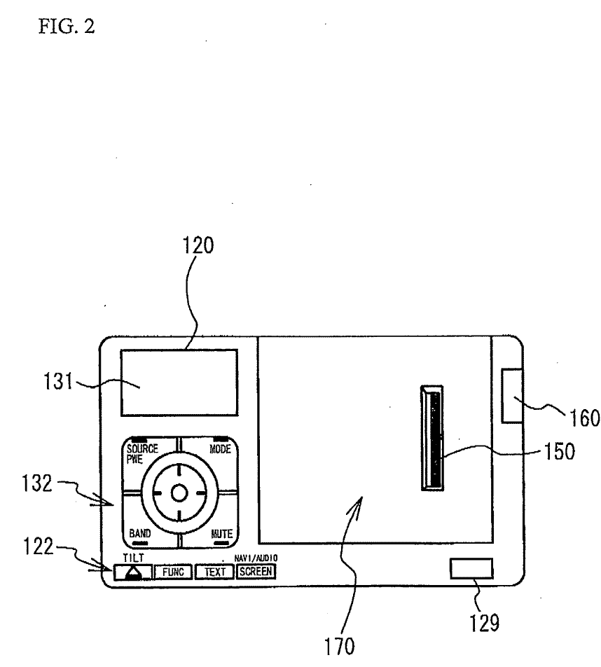

FIG. 2 shows the in-vehicle apparatus 100 (the front face portion 120), from which the portable apparatus 10 is removed. There is provided an attached/detached portion 170 in which a recess portion is defined for attaching the portable apparatus 10, at the front face portion 120 of the in-vehicle apparatus 100. The upper portion of the attached detached portion 170 is opened. The attached/detached portion 170 is provided with: a connector 150 for electrically coupling the in-vehicle apparatus 100 and the portable apparatus 10; and a lock mechanism (not shown) for securing the portable apparatus 10 to the front face portion 120. When a detach button 160 provided at the front face portion 120 is operated, a lock mechanism, not shown, is unlocked and the portable apparatus 10 is detachable from the in-vehicle apparatus 100.

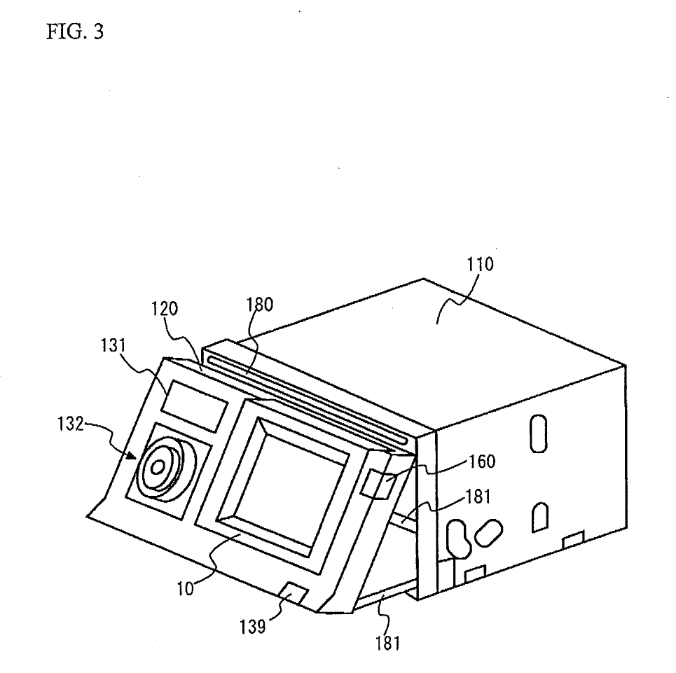

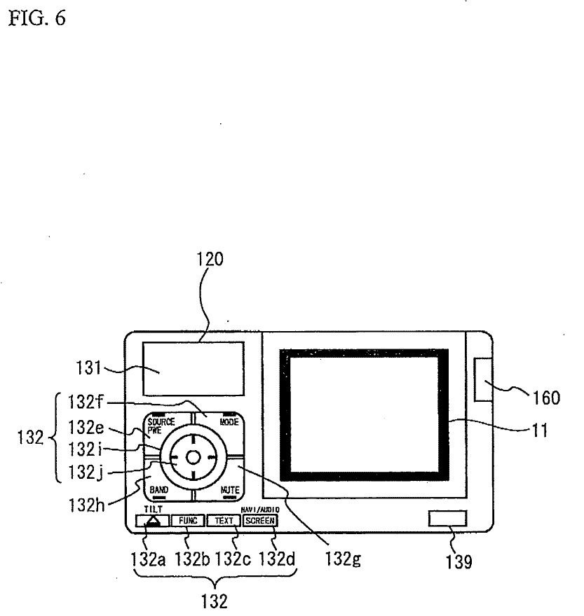

FIG. 3 shows a state of tilting the front face portion 120 against the in-vehicle apparatus main body 110 to expose a CD insertion/ejection slot 180. By driving a slider 181 shown in FIG. 3 with a drive mechanism, not shown, the front face portion 120 can be tilted (moved) against the in-vehicle apparatus main body 110. By tilting operation, the CD insertion/ejection slot 180 provided in the in-vehicle apparatus main body 110 is exposed, so a CD can be inserted or ejected. There is provided an operation button (a tilt/eject button 132a shown in FIG. 6), at the front face portion 120 of the in-vehicle apparatus 100, and a tilt angle can be set according to the operation of the button.

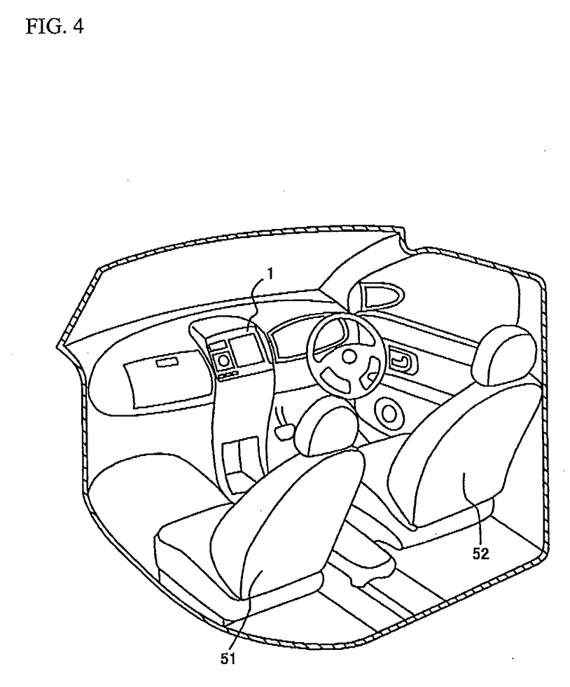

FIG. 4 illustrates an example of mounting the in-vehicle system 1 in a vehicle. The in-vehicle system 1 is disposed in a dashboard portion substantially in the middle of a front-passenger's seat 51 and a driver's seat 52, as shown in FIG. 4, for example. Here, a GPS antenna, not shown, of a GPS information receiver 133 is located on the dashboard or attached at a car inner side of a front glass.

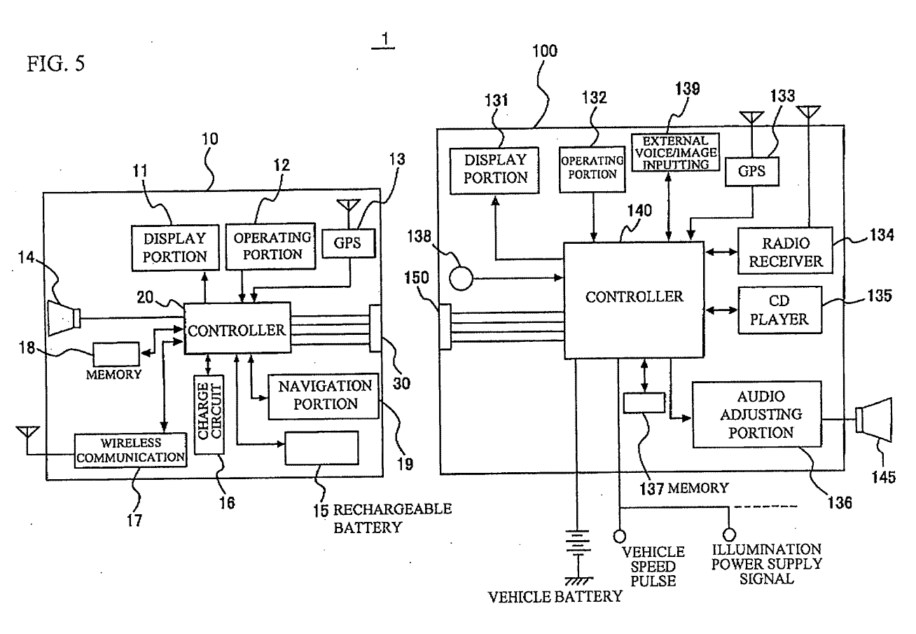

FIG. 5 is a block diagram showing a schematic configuration of the in-vehicle system 1. The in-vehicle apparatus 100 and the portable apparatus 10 are electrically connected by connectors. The connector 150 is provided at the in-vehicle apparatus 100 side, and a connector 30 is provided at the portable apparatus 10. By connecting the connectors 150 and 30, various signals are sent and received between the in-vehicle apparatus 100 and the portable apparatus 10 to function as the in-vehicle system 1. The connectors 150 and 30 are respectively provided with power supply terminals for supplying power to the portable apparatus 10 from the battery of the vehicle. When the portable apparatus 10 is connected to the in-vehicle apparatus 100 and the power is supplied to the in-vehicle apparatus 100, the power is also supplied to the portable apparatus 10 via the power supply terminals.

The in-vehicle apparatus 100 is provided with: the display portion 131; the operating portion 132; the GPS information receiver 133; a radio receiver 134 (corresponding to a controlled portion) serving as an audio apparatus; a CD player 135 (corresponding to a controlled portion); an audio adjusting portion 136; a memory 137; a microphone 138; an external voice/image inputting portion 139; a controller 140; and the connector 150. The in-vehicle apparatus 100 is activated by supplying the power from the battery of the vehicle, when the engine key is positioned at Acc or ON.

Hereinafter, the function of each part will be described in detail. The display portion 131 is provided with a liquid crystal panel and a backlight, and displays a frequency of the received broadcasting, a track number of music being played, a music name being played, and the like, according to the 13-segment display. The operating portion 132 is provided for selectively changing the operation mode of the in-vehicle apparatus 100, and for operating in various modes that have been changed. The operating portion 132 is provided with a group of buttons including: the tilt/eject button 132a; a function (hereinafter referred to as FUNC)/AF button 132b; a TEXT button 132c; a SCREEN button 132d; a SOURCE/PWR button 132e; a MODE button 132f; a MUTE button 132g; a BAND change button 132h; a rotary button 132i; a cross key/enter key button 132j, as shown in FIG. 6.

Here, a description will be given of the control by operating the buttons. First, a description will be given of switching the display between the portable apparatus 10 and the in-vehicle apparatus 100 by operating the SOURCE/PWR button 132e. The in-vehicle apparatus 100 turns on when the SOURCE/PWR button 132e of the in-vehicle apparatus 100 is pushed. When the SOURCE/PWR button 132e is pushed for a short period of time while the portable apparatus 10 is on, the source is changed to the CD playing or radio broadcasting. At this time, the information on the selected source is displayed on the display portion 131 of the in-vehicle apparatus 100, and the navigation image is displayed on a display portion 11 of the portable apparatus 10, without relation to the source. Next, when the SCREEN button 132d is pushed, the navigation image displayed on the display portion 11 of the portable apparatus 10 can be changed to an image corresponding to the source selected at the in-vehicle apparatus 100.

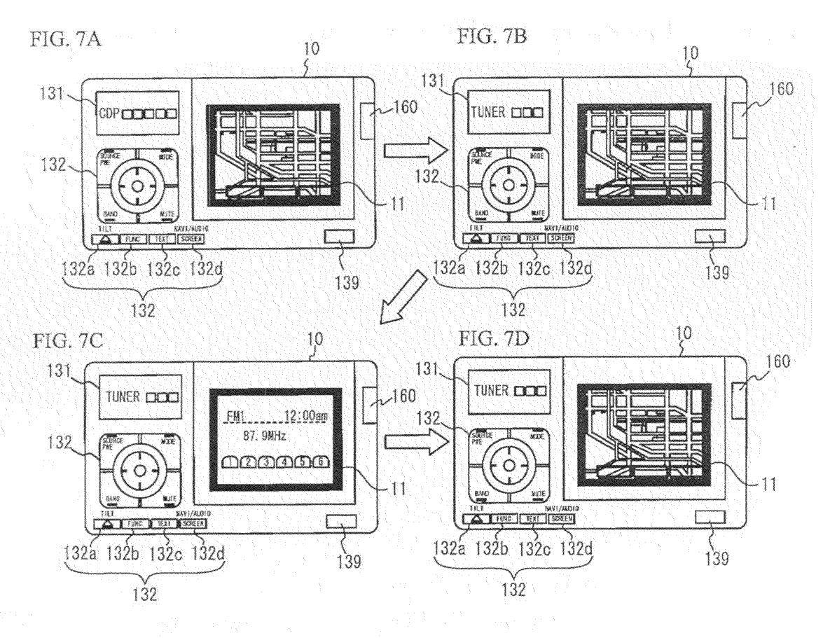

FIG. 7A shows a state where the portable apparatus 10 is attached to the in-vehicle apparatus 100 while the CD is being played and a navigation image is being displayed on the portable apparatus 10. When the SOURCE/PWR button 132e is pushed in the state of FIG. 7A and the source is changed from the CD playing to the radio broadcasting, the information on the radio source is displayed on the display portion 131, as shown in FIG. 7B. Also, the navigation image remains being displayed on the display portion 11 of the portable apparatus 10. Then, when a user pushes the SCREEN button 132d, the image corresponding to the source being processed by the in-vehicle apparatus 100 is displayed on the display portion 11 of the portable apparatus 10, as shown in FIG. 7C (radio image is displayed in FIG. 7C). A touch panel, described later, is provided in the display portion 11 of the portable apparatus 10. A user is capable of operating the source currently being processed, by selecting the operation buttons displayed on the display portion 11.

In addition, when the SCREEN button 132d is pushed with the radio screen being displayed on the display portion 11, it is possible to return to the navigation image from the radio image, as shown in FIG. 7D. When the portable apparatus 10 is removed from the in-vehicle apparatus 100, the operation of the SCREEN button 132d is invalid. Furthermore, when a USB (Universal Serial Bus) or the like is connected to the external voice/image inputting portion 139 with the portable apparatus 10 removed from the in-vehicle apparatus 100, it is possible to prevent the change to the USB source, even if the SOURCE/PWR button 132e is pushed.

Next, a description will be given of the operation of the front face portion 120 by use of the tilt/eject button 132a. When the tilt/eject button 132a is operated in a first manner (for example, short press), the front face portion 120 tilts at an angle (for example, 60 degrees) to expose the CD insertion/ejection slot 180. When the tilt/eject button 132a is operated in a second manner (for example, long press), the front face portion 120 tilts by a given angle (for example, five degrees) every time.

Referring back to FIG. 5, the GPS information receiver 133 includes a GPS antenna and a tuner, and receives GPS signals from a satellite. The GPS signal received by the GPS information receiver 133 is output through the controller 140, the connector 150, the connector 30, and a controller 20, to a navigation portion 19 of the portable apparatus 10, and then the position of the vehicle in which the in-vehicle apparatus 100 having the portable apparatus 10 therein is determined based on the GPS signal. Herein, the GPS signal may be output to the navigation portion of the portable apparatus 10 through the controller 140, instead of through the controller 20. Alternatively, the GPS information receiver 133 may be composed of the GPS antenna only, so that the GPS signal received by the GPS antenna may be output to the tuner of a GPS information receiver 13, described later, without through the controller 140 or the controller 20. Further alternatively, the GPS signal received by a GPS antenna may be output through the controller 20 to the tuner of the GPS information receiver 13 without through the controller 140. Various changes may be made as necessary.

The radio receiver 134 has an antenna and a tuner, receives broadcast waves such as AM broadcasting, FM broadcasting, and sound multiplex broadcasting, outputs stereo audio signals, receives and demodulates multiplex data, and outputs the demodulated signal to the controller 140. The CD player 135 reproduces the data stored in the CD, and outputs the reproduced signal to the controller 140. Herein, the demodulated signal output from the radio receiver 134 may be output to the audio adjusting portion 136, described later, without through the controller 140.

The audio adjusting portion 136 implements signal processing such as volume control or tone control on an audio signal received or demodulated by the radio receiver 134 or the audio signal reproduced by the CD player 135, and then outputs the processed signal to a speaker 145. The memory 137 may be composed of a RAM (Random Access Memory) from which data is readable and into which data is writable, and temporarily stores information necessary for control. The microphone 138 is provided for hands-free communication, and takes in user's voices in the vehicle. The external voice/image inputting portion 139 is provided with a connection terminal with an external device such as a USB memory, portable audio device, or the like so that an audio signal or data from the external device may be input. The external voice/image inputting portion 139 then sends the signal or data to the controller 140, and outputs the audio signal, data, or the like to the external device connected.

The controller 140 controls the radio receiver 134, the CD player 135, and the audio adjusting portion 136, according to the operation by means of the operating portion 132. Also, the controller 140 outputs various signals through the connector 150 to the portable apparatus 10, and controls the in-vehicle apparatus 100 on the basis of the various signals input from the portable apparatus 10. For example, the controller 140 outputs the GPS signal received by the GPS information receiver 133 or the audio signal input through the microphone 138, to the portable apparatus 10 by way of the connector 150. Here, the audio signal input through the microphone 138 may be output to the portable apparatus 10 by way of the connector 150, without through the controller 140. In addition, the voice on communication over a mobile phone connected to the portable apparatus 10 is input through the connector 150 into the controller 140, and is then output through the audio adjusting portion 136 to the speaker 145. Furthermore, the controller 140 acquires an operation signal corresponding to a menu image of various modes displayed on the display portion 11 of the portable apparatus 10, from the controller 20 of the portable apparatus 10, and then controls the radio receiver 134 and the CD player 135.

Also, the power is supplied to the controller 140 from the battery mounted in the vehicle. When the portable apparatus 10 is connected, the controller 140 outputs the power supplied from the battery to the portable apparatus 10. Here, a vehicle speed pulse and an illumination power supply signal are input into the controller 140 from a vehicle. The controller 140 transfers such input vehicle speed pulse to the controller 20 of the portable apparatus 10. Meanwhile, the vehicle speed pulse may be configured not to be input.

Next, a description will be given of the portable apparatus 10. The portable apparatus 10 is provided with: the display portion 11; an operating portion 12; the GPS information receiver 13; a speaker 14; a rechargeable battery 15; a charge circuit 16; a wireless communication transmitter/receiver 17; a memory 18; the navigation portion 19; the controller 20; and the connector 30.

Hereinafter, functions of the components will be described in detail. The display portion 11 is provided with a liquid crystal panel and a backlight, and is capable of displaying map information generated by the navigation portion 19 and guiding path information to a destination, the received broadcasting frequency transferred from the in-vehicle apparatus 100, a music track number played, music name played, and the like. The display portions 11 and 131 may employ a flat panel display other than a liquid crystal panel. Examples are organic light emitting display, plasma display panel, cold-cathode flat panel display, or the like.

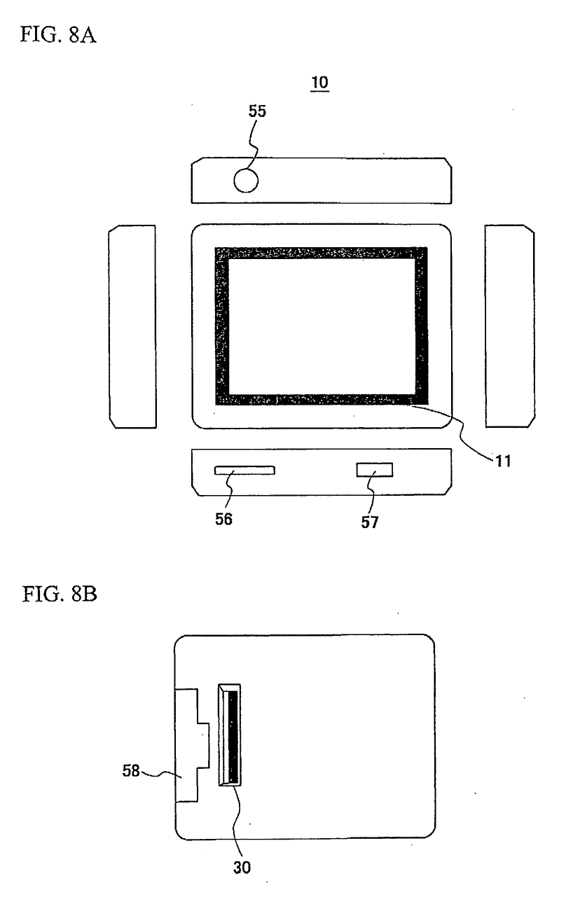

The operating portion 12 includes a power button 55 (see FIG. 8A) for powering on or off the touch panel or the portable apparatus 10. The touch panel is, for example, disposed on the display screen. When the touch panel is touched by a finger or a dedicated pen, the touched position is detected to determine whether or not there is an input operation. The power button 55 will be described later in detail.

The GPS information receiver 13 includes an antenna and a tuner, and receives the GPS signal from a satellite. Such received GPS signal is output to the navigation portion 19, and the vehicle location is detected based on the GPS signal. Meanwhile, the in-vehicle apparatus 100 is also provided with the GPS information receiver 133. However, when the portable apparatus 10 is attached to the in-vehicle apparatus 100, the location of the vehicle, in which the in-vehicle apparatus 100 having the portable apparatus 10 is mounted, is specified by use of the GPS signal (and the vehicle speed pulse) received by the GPS information receiver 133. When the portable apparatus 10 is used alone, the location thereof is specified by use of the GPS signal received by the GPS information receiver 13.

The speaker 14 is provided for outputting the audio information of the navigation portion 19, and outputs the audio information only when the portable apparatus 10 is detached from the in-vehicle apparatus 100, namely, used alone separately.

The rechargeable battery 15 supplies power to each portion of the portable apparatus 10. When the portable apparatus 10 is attached to the in-vehicle apparatus 100, the power is supplied through the power supply terminals of the connector 30 from the battery of the vehicle and the rechargeable battery 15 is charged by the charge circuit 16. Also, the charge circuit 16 is supplied with the power from the connection terminal through a USB slot (see FIG. 8A), and the rechargeable battery 15 can be charged.

The wireless communication transmitter/receiver 17 sends and receives the voice on communication over a mobile phone, and acquires the information used for navigation over the mobile phone. For example, Bluetooth, which is a wireless transmission system at 2.4 GHz band, is used for the wireless communication transmitter/receiver 17.

The memory 18 may be a RAM from which data is readable and into which the data is writable, and temporarily stores the information read for each control.

The navigation portion 19 includes a map information storing portion that acquires from an SD card or a USB memory, described later, and stores the map information used for navigation, determines current location information with GPS signal from the GPS information receiver 133 or the GPS information receiver 13, and creates an image for navigation operation. The created map image can be displayed on the display portion 11. In addition, when the in-vehicle apparatus 100 and the portable apparatus 10 are connected, the vehicle speed pulse is acquired from the vehicle so that the accuracy of the location detection of the vehicle can be improved. Optionally, the map information may be retained in the portable apparatus 10.

The controller 20 controls each part of the portable apparatus 10. Also, the controller 20 outputs various signals to the in-vehicle apparatus 100 through the connector 30, and controls the portable apparatus 10 based on the various signals input from the in-vehicle apparatus 100. For example, the controller 20 acquires the GPS signal received by the GPS information receiver 133 of the in-vehicle apparatus 100 and the vehicle speed pulse, and outputs to the navigation portion 19. Also, the controller 20 acquires the audio signal input by the microphone 138 of the in-vehicle apparatus 100 from the controller 140 of the in-vehicle apparatus 100, and controls the navigation portion 19 according to the audio signal acquired. That is to say, the navigation portion 19 can be operated in a hands-free manner. The voice on communication over the mobile phone connected to the wireless communication transmitter/receiver 17 is output to an in-vehicle apparatus side through the connector 30, and is caused to output from the speaker 145 of the in-vehicle apparatus 100. The operation signal on the menu screen or content screen displayed on the display portion 11 is output to the controller 140 of the in-vehicle apparatus 100 through the connector 30. The controller 140 controls the radio receiver 134 or the CD player 135 according to the operation signal transmitted from the controller 20 of the portable apparatus 10.

FIG. 8A shows a front view, top view, bottom view, left-side view, and right-side view of the portable apparatus 10. FIG. 8B is a back view of the portable apparatus 10. The top face of the portable apparatus 10 is provided with the power button 55 for turning on or off the power of the portable apparatus. The bottom face of the portable apparatus 10 is provided with: an SD memory card slot 56; and the USB slot 57. By inserting the SD (Secure Digital) card or the USB memory storing the map information into the slots, the controller 20 reads the map information from the SD card or the USB memory and outputs the map information to the navigation portion 19.

The power of the portable apparatus 10 is turned on or off by the control of the in-vehicle apparatus 100, when the portable apparatus is attached to the in-vehicle apparatus 100. In addition, when the portable apparatus 10 is removed from the in-vehicle apparatus 100 and used alone, the power is operated on the basis of the on and off operations of the power button 55.

At a backside of the portable apparatus 10, there are provided: the connector 30 electrically connected with the in-vehicle apparatus 100; and an engagement portion 5B to be engaged with a lock mechanism (not shown) provided at the in-vehicle apparatus 100 side.

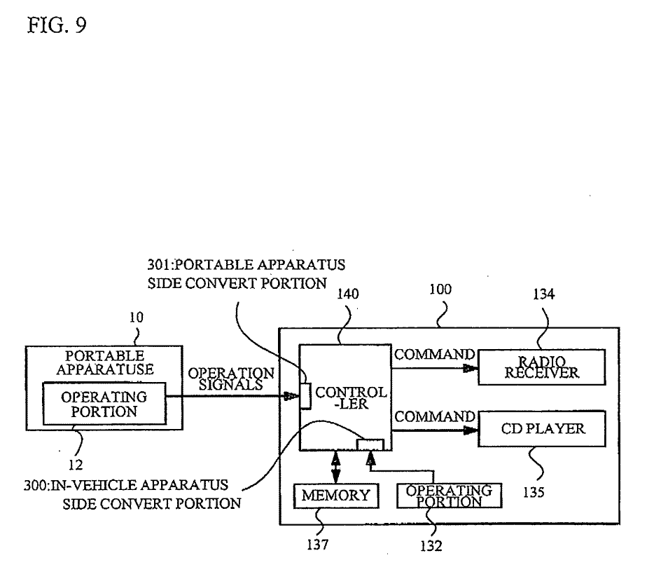

In the following, the controlled portion will be described. FIG. 9 is a schematic view for describing a configuration where the radio receiver 134 and the CD player 135 serving as the controlled portions are controlled, and is a block view where main blocks are taken from the blocks illustrated in FIG. 5. Referring to FIG. 9, the operation signals are transmitted from the operating portion 12 (for example, a touch panel of the display portion 11) of the portable apparatus 10 to the controller 140 of the in-vehicle apparatus 100 through the controller 20 (not sown). The controller 140 of the in-vehicle apparatus 100 transmits commands for controlling the radio receiver 134 and the CD player 135 to the radio receiver 134 and the CD player 135, respectively.

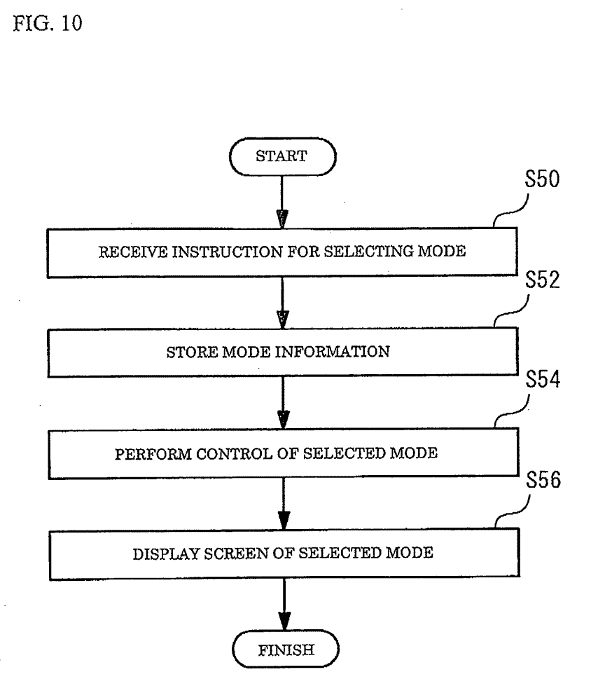

Next, the operation of the controller 140 will be described. The in-vehicle apparatus 100 has a radio mode where the controller 140 performs a control relative to the radio receiver 134 to operate the radio, a CD mode where the controller 140 performs a control relative to the CD player 135 to operate the CD, and the like. FIG. 10 is a flowchart of the control of the controller 140 when the mode is selected. Referring to FIG. 10, a user operates the operating portion 132 of the in-vehicle apparatus 100 or the operating portion 12 of the portable apparatus 10 to select the mode where the radio receiver 134 or the CD player 135 serving as the controlled portion is controlled. The controller 140 receives instruction for selecting the mode (step S50). The controller 140 stores mode information for indicating the selected mode in the memory 137 or a memory (not shown) within the controller 140 (step S52). For example, when the controller 140 receives the operation for changing the mode into the radio more, the controller 140 stores the mode information indicating the radio mode in the memory 137 or the memory within the controller 140.

In step S52 shown in FIG. 10, the mode information is stored in the memory 137 or the memory within the controller 140, so that the in-vehicle apparatus 100 has a mode administrative function. The mode administrative function grasps whether a radio operation screen or a CD operation screen is displayed on the portable apparatus 10. The mode corresponds to the operation screen of the display portion 11 for controlling the controlled portion. In the first embodiment, the in-vehicle apparatus 100 may have the single mode for a single controlled portion, or may have plural modes for single controlled portion. That is, the plural operation screens are used for a single controlled portion.

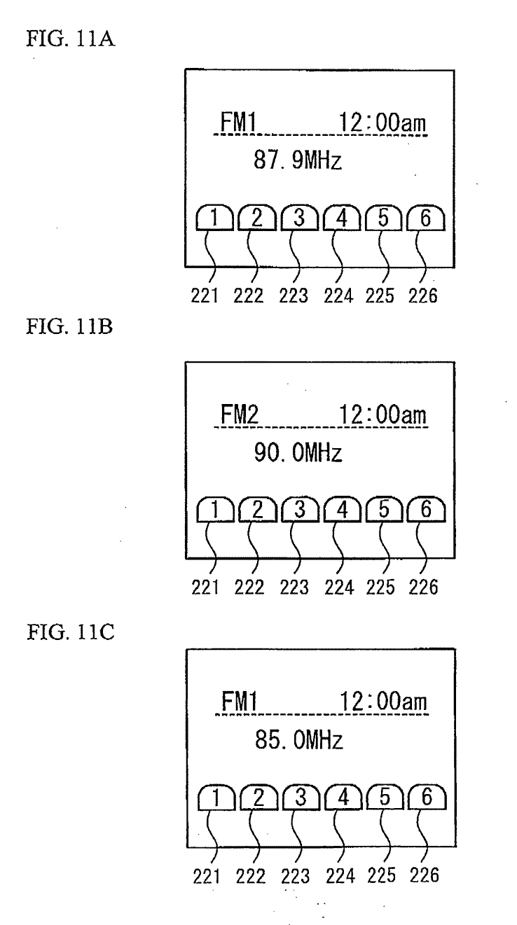

The controller 140 performs control of the selected mode (step S54). For example, when the radio mode is selected, the controller 140 turns to the frequency selected in the previous radio mode and stored in the memory 137. The controller 140 displays the screen of the selected mode (step S56). FIGS. 11A to 11C are views of an example of a screen for controlling the radio displayed on the display portion 11 of the portable apparatus 10 (hereinafter, referred to as radio operation screen). For example, when the radio mode is selected, the controller 140 displays a current frequency and operation buttons 221 to 226 on the display portion 11 of the portable apparatus 10. The radio receiver 134 receives a broadcasting of pre channel 1 (87.9 MHz) of FM, as illustrated in FIG. 11A.

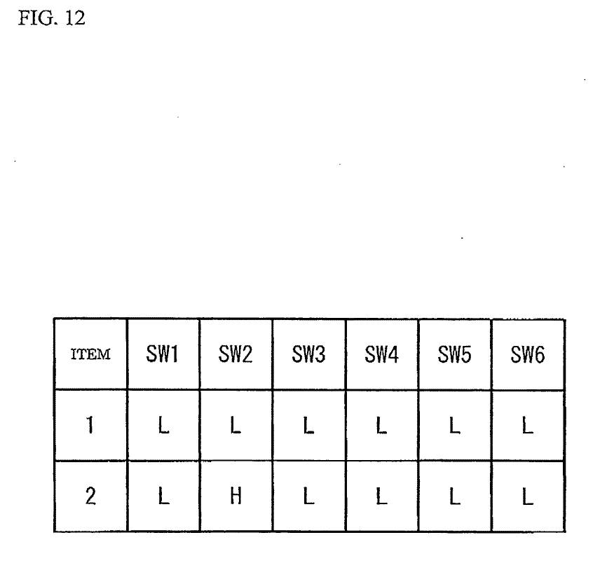

FIG. 12 is a view of an example of operation signals. When all of the operation buttons 221 to 226 are not pressed, the controller 20 of the portable apparatus 10 transmits low level as signal SW 1 to SW 6 as illustrated by an item 1 illustrated in FIG. 12. When one of the operation buttons 221 to 226 is pressed, high level is transmitted as a corresponding signal of the signals SW1 to SW6, and low level is transmitted as the other signals. As illustrated in FIG. 12, an item 2 indicates the operation signals when the operation button 222 is pressed. The controller 20 transmits the signals SW1 to SW6 to the controller 140 of the in-vehicle apparatus 100 every 100 ms. The controller 140 receives the signals SW1 to SW6, thereby recognizing the pressed button of the operation buttons 221 to 226 every 100 ms.

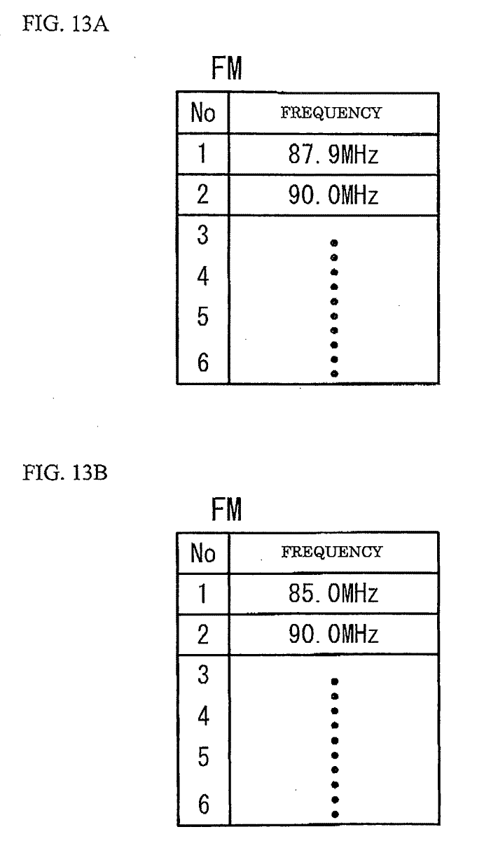

FIGS. 13A and 13B are views of an example of data stored in a memory within the controller 140 or the memory 137 (storage portion). As illustrated in FIGS. 13A to 13C, the memory 137 stores the frequencies, which correspond to radio receive modes such as FM and AM and which correspond to the numbers of the operation buttons 221 to 226 as registration information. For example, in the state illustrated in FIG. 13A, 87.9 MHz frequency corresponding to No 1 and 90.0 MHz frequency corresponding to No 2 are stored.

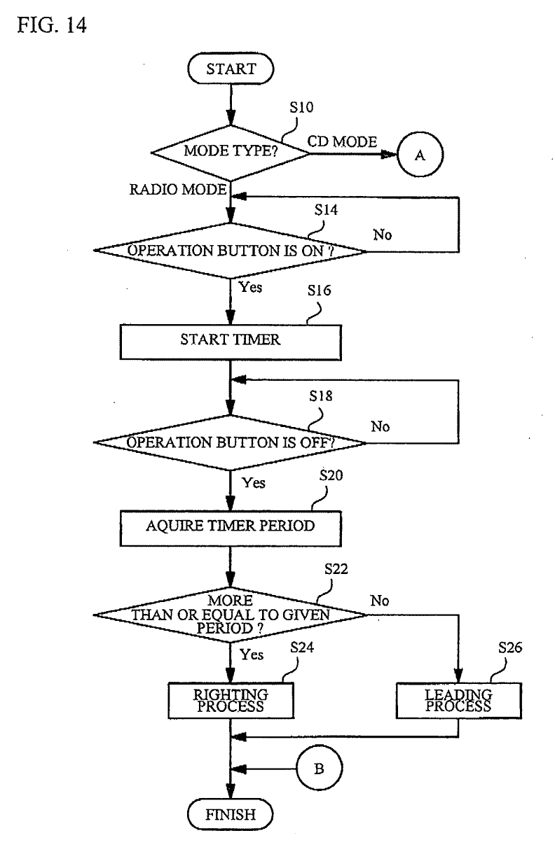

FIG. 14 is a flowchart of the operation of the controller 140 in the radio mode. Referring to FIG. 14, the controller 140 determines the radio or CD mode (step S10). The CD mode will be described later. In the radio mode, the controller 140 determines which switch of the operation buttons 221 to 226 is ON, on the basis of the operation signals (step S14). When No is determined, the processing returns to step S14. When one of the operation buttons 221 to 226 is ON, that is, when one of the signals SW1 to SW6 is the high level, for example, in the item 2 illustrated in the FIG. 12, the controller 140 starts timer (step S16). For example, the operation button 222 is pressed in the radio operation screen shown in FIG. 11A. The signal SW2 is high level and the other signals SW are the low level as operation signals, in the item 2 as illustrated in FIG. 12. The operation signals are transmitted to the controller 140 by the controller 20 in response to press the operation buttons 221 to 226 displayed on the display portion 11, and may be any other than the high and low levels.

Referring to FIG. 14, the controller 140 determines whether the switch of the operation button is detected to have been pressed among the operation buttons 221 to 226 in step S14 (for example; the operation button 222) is OFF (step S18). For example, when the SW2 is the low level in the item 1 illustrated in FIG. 12, the switch of the operation button 222 is determined to be OFF. The controller 140 acquires a period of the timer (step S20). The controller 140 determines whether or not the acquired period is more than or equal to the given period (step S22). Here, the given period discremates short press or long press, and is, for example, 1.5 s. Additionally, the timer may be a counter counting the number of the operation signals. In this case, the given period is the number of the counted number corresponding to the period of the long press.

No is determined in step S22, that is, the period while the operation button is being pressed is less than the given period, so that the corresponding button among the operation buttons 221 to 226 is short pressed. In this case, the controller 140 causes the radio receiver 134 to perform a reading process described below (step S26). For example, when the operation button 222 is short pressed, the controller 140 sets the received frequency of the radio receiver 134 to the frequency of No2. That is, the controller 140 selects and reads the 90 MHz frequency of No2 in the memory 137 shown in FIG. 13A. The controller 140 transmits the command for instructing the radio receiver 134 to set at 90.0 MHz frequency. Thus, the radio receiver 134 is set to be the frequency of the No 2. The controller 140 transmits frequency information to the controller 20. Accordingly, the 90.0 MHz frequency is displayed on the display portion 11. In this manner, the reading process is accomplished. The processing is then finished.

Yes is determined in step S22, that is, the period while the operation button is pressed is more than or equal to the given period, so that the corresponding button among the operation buttons 221 to 226 is long pressed. In this case, the controller 140 causes the radio receiver 134 to perform a writing process described below (step S24). That is, the current frequency is written as the frequency corresponding to No in the radio receiver 134. Briefly, the current frequency is set to the corresponding No. For example, when the broadcast in the 85.0 MHz frequency is received and the operation button 221 is long pressed as illustrated in FIG. 11C, the controller 140 changes the frequency of No 1 into the 85.0 MHz as illustrated in FIG. 13B. The processing is then finished.

As described above, in the radio mode, the controller 140 can store and select radio information (for example, a frequency) for controlling the radio receiver 134, on the basis of the selected control content (for example, the writing process of each frequency, or the leading process). In this manner, the control content includes a specific content with which the controller 140 controls the controlled portion. Further, the radio information is information for receiving the radio broadcasting, and is the frequency and the receiving mode such as FM or AM, or the like.

Further, the period while the operation signals are being input is detected. In a case where the detected period is more than or equal to a given period, the radio information (for example, frequency) is stored. In a case where the detected period is less than or equal to, the radio information is selected.

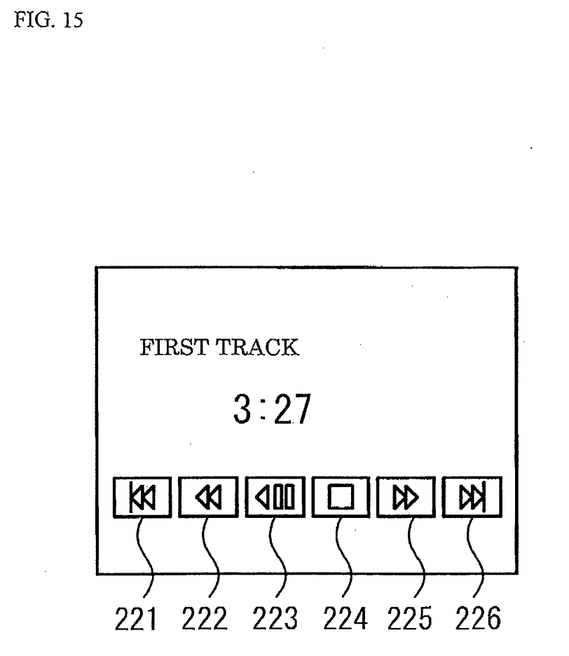

Next, a description will be given of the control of the controller 140 in the CD mode. In step S50 shown in FIG. 10, the controller 140 receives the instruction for selecting the CD mode. In step S52, the controller 140 stores the mode information indicating the CD mode in the memory 137. In step S54, the controller 140 then performs the control of the CD mode. In step S56, the controller 140 displays the screen of the CD mode on the display portion 11. FIG. 15 shows an example of a screen (hereinafter referred to as CD operation screen), displayed on the display portion 11 of the portable apparatus 10, for controlling the CD player 135.

As shown in FIG. 15, the operation buttons 221 to 226 displayed on the radio operation screen are displayed for operating the reproduction of the CD. The operation button 221 is displayed as “previous track skip button” for reproducing the track, from its beginning, previous to a currently reproducing track. The operation button 222 is displayed as “fast-rewind button” for rewinding the reproduced track. The operation button 223 is displayed as “play/pause button” for reproducing and pausing the track. The operation button 224 is displayed as “stop button” for stopping the currently reproducing track. The operation button 225 is displayed as “fast-forward button” for fast forwarding the currently reproducing track. The operation button 226 is displayed as “following track skip button” for reproducing the track, from its beginning, following to the currently reproducing track.

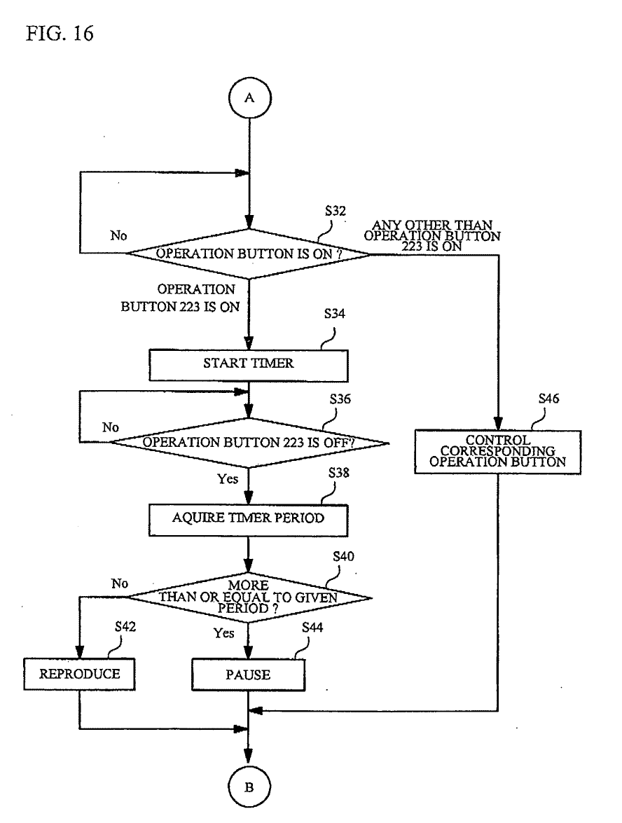

FIG. 16 is a flowchart of the operation of the controller 140 in the CD mode. When the controller 140 determines the CD mode in step S10 shown in FIG. 14, the controller 140 determines any one of the operation buttons 221 to 226 is ON based on the operation signals (step S32). When No is determined, the processing returns to step S32. When the operation button other than the operation button 223 is ON, the controller 140 performs the control corresponding to the operation button (step S46). For example, when the operation button 221 is pressed, the controller 140 transmits to the CD player 135 command for reproducing the track, from its beginning, previous to a currently reproducing track. The processing is then finished.

When the operation button 223 is ON in step S32, the controller 140 starts the timer (step S34). The controller 140 determines whether the operation button 223 is OFF (step S36). When No is determined, the processing returns to step S36. When Yes is determined, the controller 140 acquires the period of the timer (step S38). The controller 140 determines whether the acquired period is more than or equal to the given period (step S40). When No is determined, the controller 140 transmits the command of replay to the CD player 135 (step S42). When Yes is determined, the controller 140 transmits the command of pause (temporary stop) to the CD player 135 (step S44). The processing is then finished.

As described above, when the operation button is pressed in the CD mode, the controller 140 performs the corresponding control of the CD player 135 regardless of the long press or the short press of the operation buttons 221 to 226. On the other hand, when the operation button 223 is pressed, the controller 140 performs the different control of the CD player 135 on the basis of the short press or the long press.

As described with reference to FIGS. 9 to 16, when the operation signals are input to the controller 140 of the in-vehicle apparatus 100 from the portable apparatus 10, the controller 140 selects the control content (the writing and reading processes at each frequency of the radio receiver 134, or the reproduction or pause of the CD player 135) on the basis of the current mode (the radio or CD mode) of the plural modes (the radio and CD modes) and the operation signals, and the controller 140 transmits the command to the currently controlled portion (the radio receiver 134 or the CD player 135) on the basis of the selected control content. This controls the controlled portion which is currently controlled.

With this control, the controller 20 of the portable apparatus 10 has only to transmit the operation signals respectively corresponding to the operation buttons 221 to 226 displayed on the display portion 11, regardless of the radio or CD operation screen displayed on the operation screen. For example, the low or high level can be set to the operation signal in response to press the operation buttons 221 to 226, as illustrated in FIG. 12. The controller 140 of the in-vehicle apparatus 100 can select the control content on the basis of the mode corresponding to the controlled portion and the operation signals. In this manner, the operation signals are mutually used regardless of the controlled portion, thereby reducing the number of the operation signals transmitted from the portable apparatus 10 to the in-vehicle apparatus 100. In the first embodiment, the number of the operation signals can be six, which is identical to that of the operation buttons and can be six.

Also, the controller 140 detects the period while the operation signals are input, and selects the control content for controlling the controlled portion on the basis of the detected period, in steps S22 to S26 illustrated in FIG. 14 and in steps S40 to S44 illustrated in FIG. 15. This increases the varieties in the control of the controlled portion by the controller 140 of the in-vehicle apparatus 100, without increasing the operation signals.

The radio receiver 134 and the CD player 135 are described as the controlled portion within the in-vehicle apparatus 100 in the first embodiment. However, in addition to them, the in-vehicle apparatus 100 may be provided with a DVD player for reproducing a DVD, a MD player for reproducing a MD, an external apparatus player for reproducing an external apparatus connected thereto through an external interface portion such as a USB, a traffic information receiver for receiving traffic information such as VICS information or Sirius information, a digital communication receiver for receiving digital signals, an RDS-TMC portion, and a Navi controller for performing control according to navigation, as the controlled portions.

In the first embodiment, the signals (hereinafter referred to as in-vehicle apparatus side signals), which are transmitted from the 132 to the controller 140 of the in-vehicle apparatus 100 when a user operates the 132 of the in-vehicle apparatus 100, differ from the signals (hereinafter referred to as portable apparatus side signals), which are transmitted from the controller 20 of the portable apparatus 10 to the controller 140 of the in-vehicle apparatus 100 when the user operates the operating portion 12 of the portable apparatus 10, as illustrated in FIG. 9. The controller 140 of the in-vehicle apparatus 100 is provided with a in-vehicle apparatus side converter 300 for converting the in-vehicle apparatus side signals and a portable apparatus side converter 301 for converting the portable apparatus side signals. The in-vehicle apparatus side and portable apparatus side signals are converted into the identical signals through these in-vehicle apparatus side and portable apparatus side converts 300 and 301. The controller 140 of the in-vehicle apparatus 100 determines what process is controlled for the controlled portion such as the radio receiver 134 or the CD player 135 is controlled, on the basis of the identical signals and the mode (for example, the radio or CD mode). The controller 140 then controls the controlled portion.

Correspondingly, the in-vehicle apparatus side and portable apparatus side signals may be configured to be identical. In this case, it is not necessary to provide the in-vehicle apparatus side and portable apparatus side converts 300 and 301 separately. A single converter may be provided for converting the in-vehicle apparatus side and portable apparatus side signals into the signals which the controller 140 is able to process.

With such a configuration, the controller 140 of the in-vehicle apparatus 100 has only to be provided with the single converter, thereby simplifying the configuration of the controller 140 of the in-vehicle apparatus 100. Further, the operating portion 132 of the in-vehicle apparatus 100 and the controller 20 of the portable apparatus 10 transmit the identical signals to the controller 140 of the in-vehicle apparatus side, whereby the controller 140 performs the identical process for any of the signals. This simplifies the configuration of the portable apparatus 10.

Although the first embodiment has described the portable apparatus 10 of the navigation apparatus as a portable apparatus, the portable apparatus may be any electronic apparatus other than the navigation apparatus. Additionally, the navigation apparatus displays the position of its own car on the map information, and navigates a user to the destination when the destination is set by the user.

Although the CD player 135 is provided in the in-vehicle apparatus 100 as illustrated in FIG. 5, a CD player, a DVD player, a blue-ray player, or a HD-DVD may be provided as an optical disk storage media reproducing portion. In a case where the DVD player is provided with the in-vehicle apparatus 100, the moving image information of the DVD may be reproduced by the portable apparatus 10.

A one-seg TV tuner may be provided in the portable apparatus 10, and a full-seg TVC tuner may be provide in the in-vehicle apparatus 100. In this case, the portable apparatus 10 is attached to select to use the one-seg TV tuner or the full-seg TVC tuner. Alternatively, the full-seg TVC tuner may be automatically changed.

Also, traffic information receiver, which receives traffic information such as VICS information over road-vehicle-communication, is omitted in the in-vehicle apparatus 100 according to the first embodiment illustrated in FIG. 5. Actually, the in-vehicle apparatus 100 has the traffic information receiver.

The portable apparatus 10 may have a map data storage portion composed of a nonvolatile memory such as a flash memory, a compact hard disk having a 1.8-inch size, or the like. Further, they may be composed of a detachable IC memory card (a SD card, a mini SD, a memory stick, a compact flash (registered trademark) or the like), or a card type HDD (microdrive).

Although a few specific exemplary embodiments employed in the present invention have been shown and described, it would be appreciated by those skilled in the art that changes may be made in these exemplary embodiments without departing from the principles and spirit of the invention, the scope of which is defined in the claims and their equivalents.

1. An electronic apparatus from which a portable apparatus is detachable, and which includes a controller being capable of controlling a controlled portion, wherein:
the controller recognizes a current mode of the controlled portion when an operation signal is input to the controller from the portable apparatus, selects a control content on the basis of the current mode and the operation signal, and controls the controlled portion currently being controlled on the basis of the selected control content.

2. The electronic apparatus of claim 1, wherein the controller detects a period while the operation signal is being input, and selects the control content of the controlled portion on the basis of the detected period.

3. The electronic apparatus of claim 1, wherein the portable apparatus is a navigation apparatus displaying map information.

4. The electronic apparatus of claim 1, wherein:
the controlled portion is a radio receiver for receiving radio broadcasting; and
the controller stores or selects radio information for controlling the radio receiver, on the basis of the selected control content.

5. The electronic apparatus of claim 2, wherein the portable apparatus is a navigation apparatus displaying map information.

6. The electronic apparatus of claim 2, wherein:
the controlled portion is a radio receiver for receiving radio broadcasting; and
the controller stores or selects radio information for controlling the radio receiver, on the basis of the selected control content.

7. The electronic apparatus of claim 3, wherein:
the controlled portion is a radio receiver for receiving radio broadcasting; and
the controller stores or selects radio information for controlling the radio receiver, on the basis of the selected control content.

8. The electronic apparatus of claim 4, wherein the controller detects the period while the operation signal is being input, and stores the radio information when the detected period is more than or equal to a given period or selects the radio information when the detected period is less than or equal to the given period.

9. The electronic apparatus of claim 6, wherein the controller detects the period while the operation signal is being input, and stores the radio information when the detected period is more than or equal to a given period or selects the radio information when the detected period is less than or equal to the given period.

10. The electronic apparatus of claim 7, wherein the controller detects the period while the operation signal is being input, and stores the radio information when the detected period is more than or equal to a given period or selects the radio information when the detected period is less than or equal to the given period.

11. An electronic system including a portable apparatus having an operating portion and an electronic apparatus having a controller being capable of controlling a plurality of controlled portions, wherein:
the controller recognizes a current mode of the controlled portion when an operation signal is input to the controller from the portable apparatus, selects a control content on the basis of the current mode and the operation signal, and controls the controlled portion currently being controlled on the basis of the selected control content.

12. The electronic system of claim 11, wherein the operating portion includes a touch panel.

13. The electronic system of claim 11, wherein the portable apparatus is a navigation apparatus displaying map information.

14. The electronic system of claim 11, wherein:
the controlled portion is a radio receiver for receiving radio broadcasting; and
the controller stores or selects radio information for controlling the radio receiver, on the basis of the selected control content.

15. The electronic system of claim 12, wherein the portable apparatus is a navigation apparatus displaying map information.

16. The electronic system of claim 13, wherein:
the controlled portion is a radio receiver for receiving radio broadcasting; and
the controller stores or selects radio information for controlling the radio receiver, on the basis of the selected control content.

17. The electronic system of claim 14, wherein the controller detects the period while the operation signal is being input, and stores the radio information when the detected period is more than or equal to a given period or selects the radio information when the detected period is less than or equal to the given period.

18. The electronic system of claim 15, wherein:
the controlled portion is a radio receiver for receiving radio broadcasting; and
the controller stores or selects radio information for controlling the radio receiver, on the basis of the selected control content.

19. The electronic system of claim 16, wherein the controller detects the period while the operation signal is being input, and stores the radio information when the detected period is more than or equal to a given period or selects the radio information when the detected period is less than or equal to the given period.

20. The electronic system of claim 18, wherein the controller detects the period while the operation signal is being input, and stores the radio information when the detected period is more than or equal to a given period or selects the radio information when the detected period is less than or equal to the given period.
